(19) United States
(12) Patent Application Publication
(10) Pub. No.: US 2014/0053468 A1
(43) Pub. Date: Feb. 27, 2014

(54) FRONT DOOR BRACKET MOUNTING APPARATUS IN A VENDING MACHINE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: YUN-LUNG CHEN, New Taipei (TW); CHIN-WEN YEH, New Taipei (TW); YANG XIAO, Wuhan (CN); CHAO FENG, Wuhan (CN)

(21) Appl. No.: 13/912,502

(22) Filed: Jun. 7, 2013

(30) Foreign Application Priority Data
Aug. 24, 2012 (CN) 2012103037973

(51) Int. Cl. E06B 7/28

(52) U.S. Cl. CPC E06B 7/28
USPC 49/463

(57) ABSTRACT

A mounting apparatus for front door bracket in vending machine includes a door body, a bracket mounted on the door body, and a fixing plate fixed on the bracket. Two first fixing tabs are extended from the bracket. A first through hole is defined in each first fixing tab. Two bending portions are extended from the base plate corresponding to the two first fixing tabs. A first mounting hole is defined in each of the two bending portions corresponding to the first through hole. Two first fasteners pass through the corresponding first through holes and the first mounting holes to fix the bracket on the door body. The fixing plate is fixed between the two bending portions on the bracket. The two bending portions resist against the fixing plate on the base plate.

### BACKGROUND

1. Technical Field

The present disclosure relates to a mounting apparatus for a front door bracket in a vending machine.

2. Description of Related Art

Vending machines allow customers to buy a lot of merchandise, such as bottled water, newspapers twenty four hours a day. A typical vending machine usually includes a cabinet and a front door rotatably fixed on the cabinet. The front door is mounted on the cabinet by multiple hinges and fixing plates, which increases weight of the front door. When the front door is opened and closed numerous times, the hinges and fixing plates may deform and the vending machine may malfunction.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a mounting apparatus for front door bracket in a vending machine.

FIG. 2 is an enlarged view of a circled portion II of FIG. 1.

FIG. 3 is an enlarged view of a circled portion III of FIG. 1.

FIG. 4 is an enlarged view of a circled portion IV of FIG. 1.

FIG. 5 is an assembled view of the mounting apparatus for front door bracket of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

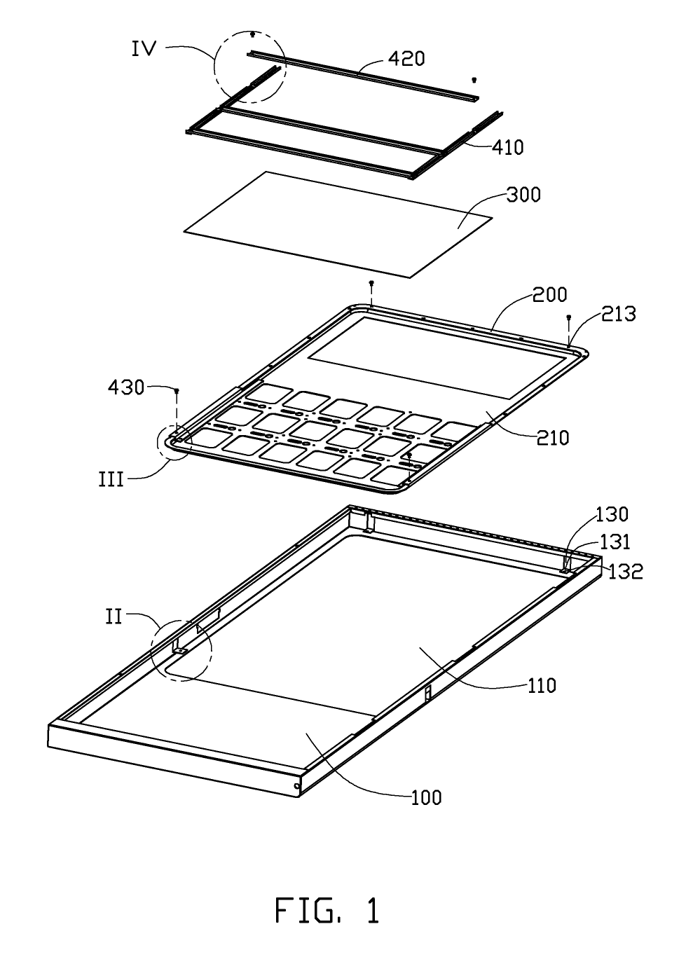

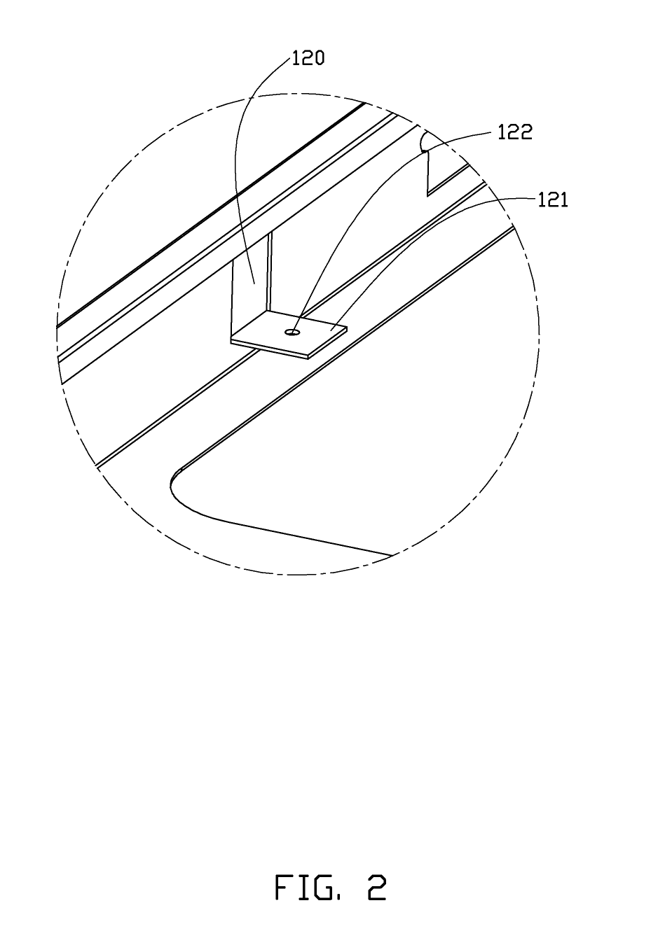

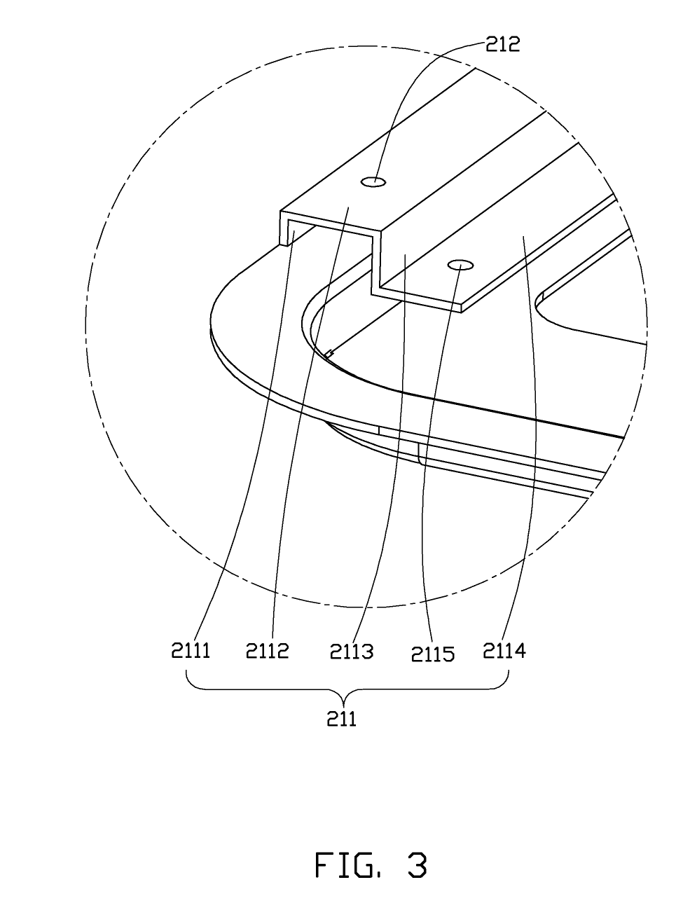

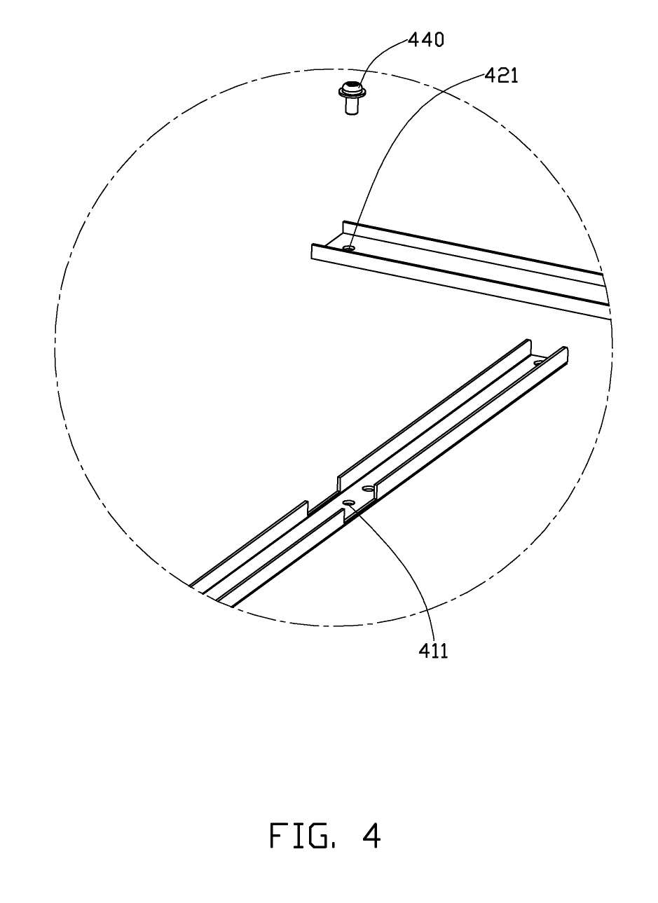

FIGS. 1 to 4 show a mounting apparatus for front door bracket in a vending machine. The vending machine includes a door body 100, a bracket 200 mounted on the door body 100, and a fixing plate 300 fixed on the bracket 200.

A first opening 110 is defined in the door body 100. The bracket 200 is mounted in the first opening 110 and extends to an outside of the door body 100. Two second openings 120 are defined on a left side and a right side of the door body 100. A first fixing tab 121 is horizontally extended from a bottom edge of each of the two second openings 120. A first through hole 122 is defined in each first fixing tab 121. Two third openings 130 are defined on a front side of the door body 100. A second fixing tab 131 is horizontally extended from a bottom edge of each of the two third openings 130. A second through hole 132 is defined in each second fixing tab 131.

The bracket 200 includes a base plate 210. Two ladder-shaped bending portions 211 are oppositely extended from two side edges of the base plate 210. Each of the two bending portions 211 includes a supporting arm 2111 perpendicularly extended from the base plate 210, a mounting arm 2112 horizontally extended from a top edge of the supporting arm 2111, a connecting arm 2113 perpendicularly extended from a distal end of the mounting arm 2112, and a restriction arm 2114 horizontally extended from a bottom edge of the connecting arm 2113. A first mounting hole 212 is defined in each mounting arm 2112 corresponding to the first through hole 122. Two second mounting holes 213 are defined in a front side of the base plate 210 corresponding to the second through holes 132. A plurality of third mounting holes 2115 are defined in the restriction arm 2114. In one embodiment, a distance between the mounting arm 2112 and the base plate 210 is greater than a distance between the restriction arm 2114 and the base plate 210. A height of the fixing plate 300 is less than the distance between the restriction arm 2114 and the base plate 210. A width of the fixing plate 300 is greater than a distance between the two restriction arms 2114. A dimension of the first through holes 122 is equal to that of the first mounting holes 212. A dimension of the second through holes 132 is equal to that of the second mounting holes 213.

The fixing plate 300 is fixed on the bracket 200 by a plurality of locating bars 410 and mounting bars 420. A plurality of third through holes 421 are defined in each mounting bar 420 corresponding to the plurality of third mounting holes 2115. A plurality of fourth through holes 411 are defined in each locating bar 410 corresponding to the plurality of third mounting holes 2115. In one embodiment, a dimension of the plurality of third through holes 421 is equal to that of the plurality of fourth through holes 411 and the plurality of third mounting holes 2115.

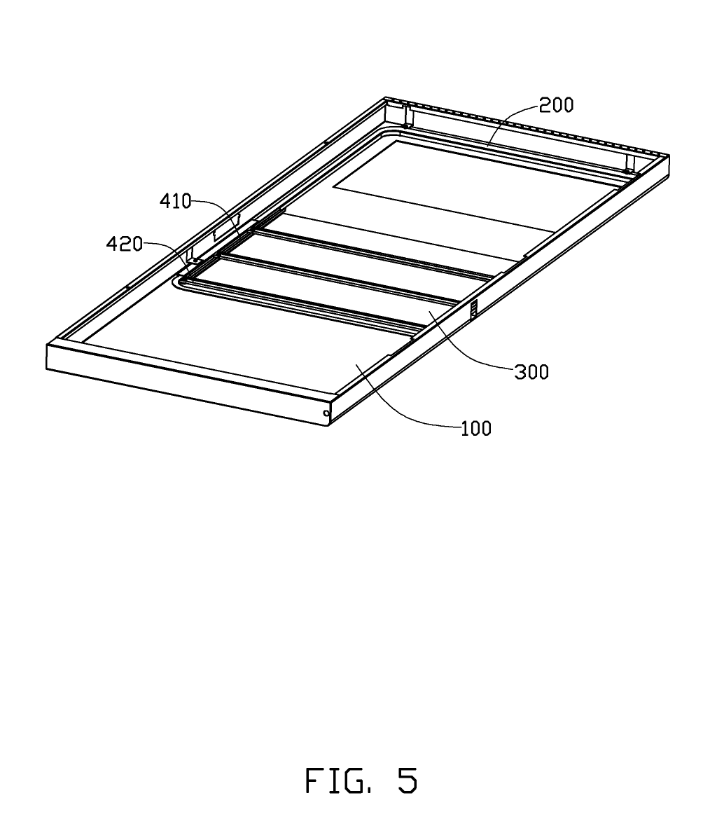

FIGS. 1 to 5 show that in assembly, the bracket 200 is located in the first opening 110 of the door body 100. The first through holes 122 are aligned with the corresponding first mounting holes 212. The second through holes 132 are aligned with the corresponding second mounting holes 213. A plurality of first fasteners 430 pass through the corresponding first through holes 122 and the first mounting holes 212, the second through holes 132 and the second mounting holes 213 to fix the bracket 200 on the door body 100. The fixing plate 300 is located between the two restriction arms 2114 on the bracket 200. The plurality of locating bars 410 and mounting bars 420 are located on the fixing plate 300. The plurality of third through holes 421 are aligned with the plurality of fourth through holes 411 and the plurality of third mounting holes 2115. A plurality of second fasteners 440 pass through the corresponding third through holes 421, the fourth through holes 411, and the third mounting holes 2115 to fix the fixing plate 300 on the bracket 200. The fixing plate 300 is fixed between the two restriction arms 2114. The two restriction arms 2114 resist against the fixing plate 300 on the base plate 210.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A mounting apparatus for front door bracket comprising:
a door body;
a bracket mounted on the door body; and
a fixing plate fixed on the bracket; wherein two first fixing tabs are extended from the bracket; a first through hole is defined in each of the two first fixing tabs; two bending portions are extended from the base plate corresponding to the two first fixing tabs; a first mounting hole is defined in each of the two bending portions corresponding to the first through hole; a first fastener passes through the first through hole and the first mounting hole to fix the bracket on the door body; the fixing plate is fixed between the two bending portions on the bracket; and each of the two bending portions resists against the fixing plate on the base plate.

2. The mounting apparatus for front door bracket of claim 1, further comprising a second fixing tab extending from the door body; a second through hole being defined in the second fixing tab; a second mounting holes being defined in the bracket corresponding to the second through hole; and the first fastener passes through the second through hole and the second mounting hole to fix the bracket on the door body.

3. The mounting apparatus for front door bracket of claim 2, wherein a dimension of the first through hole is equal to a dimension of the first mounting hole; and a dimension of the second through hole is equal to a dimension of the second mounting holes.

4. The mounting apparatus for front door bracket of claim 1, wherein the bracket comprises a base plate; each of the two bending portions comprises a supporting arm being perpendicularly extended from each of two side edges of the base plate, a mounting arm horizontally being extended from a top edge of the supporting arm, a connecting arm being perpendicularly extended from a distal end of the mounting arm, and a restriction arm being horizontally extended from a bottom edge of the connecting arm; the first mounting holes are defined in the corresponding mounting arms; and each of the two restriction arms resists against the fixing plate on the base plate.

5. The mounting apparatus for front door bracket of claim 4, wherein a height of the fixing plate is less than a distance between the restriction arm and the base plate; and a width of the fixing plate is greater than a distance between the two restriction arms.

6. The mounting apparatus for front door bracket of claim 4, wherein a distance between the mounting arm and the base plate is greater than a distance between the restriction arm and the base plate.

7. The mounting apparatus for front door bracket of claim 4, further comprising a plurality of third mounting holes defined in the restriction arm; the fixing plate is fixed on the bracket by a plurality of locating bars and mounting bars; a plurality of third through holes are defined in each mounting bar corresponding to the plurality of third mounting holes; a plurality of fourth through holes are defined in each of the plurality of locating bars corresponding to the plurality of third mounting holes; and a second fastener passes through each of the third through holes, the fourth through holes, and the third mounting holes to fix the fixing plate on the bracket.

8. The mounting apparatus for front door bracket of claim 7, wherein a dimension of the plurality of third through holes is equal to a dimension of the plurality of fourth through holes and a dimension the plurality of third mounting holes.

9. A mounting apparatus for front door bracket comprising:
a door body;
a bracket mounted on the door body; and
a fixing plate fixed on the bracket; wherein two first fixing tabs are extended from the bracket; a first through hole is defined in each first fixing tab; two bending portions are extended from the base plate corresponding to the two first fixing tabs; a first mounting hole is defined in each of the two bending portions corresponding to the first through hole; a first fastener passes through the first through hole and the first mounting hole to fix the bracket on the door body; each of the two bending portions comprises a restriction arm; the fixing plate is fixed between the two restriction arms on the bracket; and each of the two restriction arms resists against the fixing plate on the base plate.

10. The mounting apparatus for front door bracket of claim 9, further comprising a second fixing tab extending from the door body; a second through hole being defined in the second fixing tab; a second mounting hole being defined in the bracket corresponding to the second through hole; and the first fastener passes through the second through hole and the second mounting hole to fix the bracket on the door body.

11. The mounting apparatus for front door bracket of claim 10, wherein a dimension of the first through hole is equal to a dimension of the first mounting hole; and a dimension of the second through hole is equal to a dimension of the second mounting holes.

12. The mounting apparatus for front door bracket of claim 9, wherein the bracket comprises a base plate; each of the two bending portions comprises a supporting arm being perpendicularly extended from each of two side edges of the base plate, a mounting arm being horizontally extended from a top edge of the supporting arm, and a connecting arm being perpendicularly extended from a distal end of the mounting arm; the restriction arm is horizontally extended from a bottom edge of the connecting arm; and the first mounting holes are defined in the corresponding mounting arms.

13. The mounting apparatus for front door bracket of claim 12, wherein a height of the fixing plate is less than a distance between the restriction arm and the base plate; and a width of the fixing plate is greater than a distance between the two restriction arms.

14. The mounting apparatus for front door bracket of claim 12, wherein a distance between the mounting arm and the base plate is greater than a distance between the restriction arm and the base plate.

15. The mounting apparatus for front door bracket of claim 12, further comprising a plurality of third mounting holes defined in the restriction arm; the fixing plate is fixed on the bracket by a plurality of locating bars and mounting bars; a plurality of third through holes are defined in each mounting bar corresponding to the plurality of third mounting holes; a plurality of fourth through holes are defined in each of the plurality of locating bars corresponding to the plurality of third mounting holes; and a second fastener passes through each of the third through holes, the fourth through holes, and the third mounting holes to fix the fixing plate on the bracket.

16. The mounting apparatus for front door bracket of claim 15, wherein a dimension of the plurality of third through holes is equal to a dimension of the plurality of fourth through holes and a dimension of the plurality of third mounting holes.
